(19) United States
(12) Patent Application Publication
(10) Pub. No.: US 2018/0132668 A1
(43) Pub. Date: May 17, 2018

(54) Bread Storage Container

(71) Applicant: Alexandra Lyubkin, Sunny Isles Beach, FL (US)

(72) Inventor: Alexandra Lyubkin, Sunny Isles Beach, FL (US)

(21) Appl. No.: 15/352,740

(22) Filed: Nov. 16, 2016

(51) Int. Cl. A47J 47/12

(52) U.S. Cl. CPC A47J 47/12

(57) ABSTRACT

A storage container for bread includes a housing that defines an internal space. The housing has a top that is open. The container comprises a lid that is extendible. The lid is substantially complementary to the top when the lid is in a fully extended configuration. The lid is biased to a contracted configuration such that the lid selectively conforms to a partial loaf of bread. A detector is coupled to the housing. The top is positioned in the housing such that the housing is configured to insert a loaf of bread through the top into the internal space. The lid is sealably and slidably couplable to the housing to close the top and seal the internal space. The detector is configured to measure and indicate the pressure differential between the internal space and the atmospheric pressure.

### BACKGROUND OF THE DISCLOSURE

### Field of the Disclosure

The disclosure relates to storage containers and more particularly pertains to a new storage container for bread.

### SUMMARY OF THE DISCLOSURE

An embodiment of the disclosure meets the needs presented above by generally comprising a housing that defines an internal space. The housing has a top that is open. The container comprises a lid that is extendible. The lid is substantially complementary to the top when the lid is in a fully extended configuration. The lid is biased to a contracted configuration such that the lid selectively conforms to a partial loaf of bread. A detector is coupled to the housing. The top is positioned in the housing such that the housing is configured to insert a loaf of bread through the top into the internal space. The lid is sealably and slidably couplable to the housing to close the top and seal the internal space. The detector is configured to measure and indicate the pressure differential between the internal space and the atmospheric pressure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a bread storage container according to an embodiment of the disclosure.

FIG. 2 is an isometric perspective view of an embodiment of the disclosure.

FIG. 3 is a side view of an embodiment of the disclosure.

FIG. 4 is a bottom view of an embodiment of the disclosure.

FIG. 5 is a cross-sectional view of an embodiment of the disclosure.

### DESCRIPTION OF THE PREFERRED EMBODIMENT

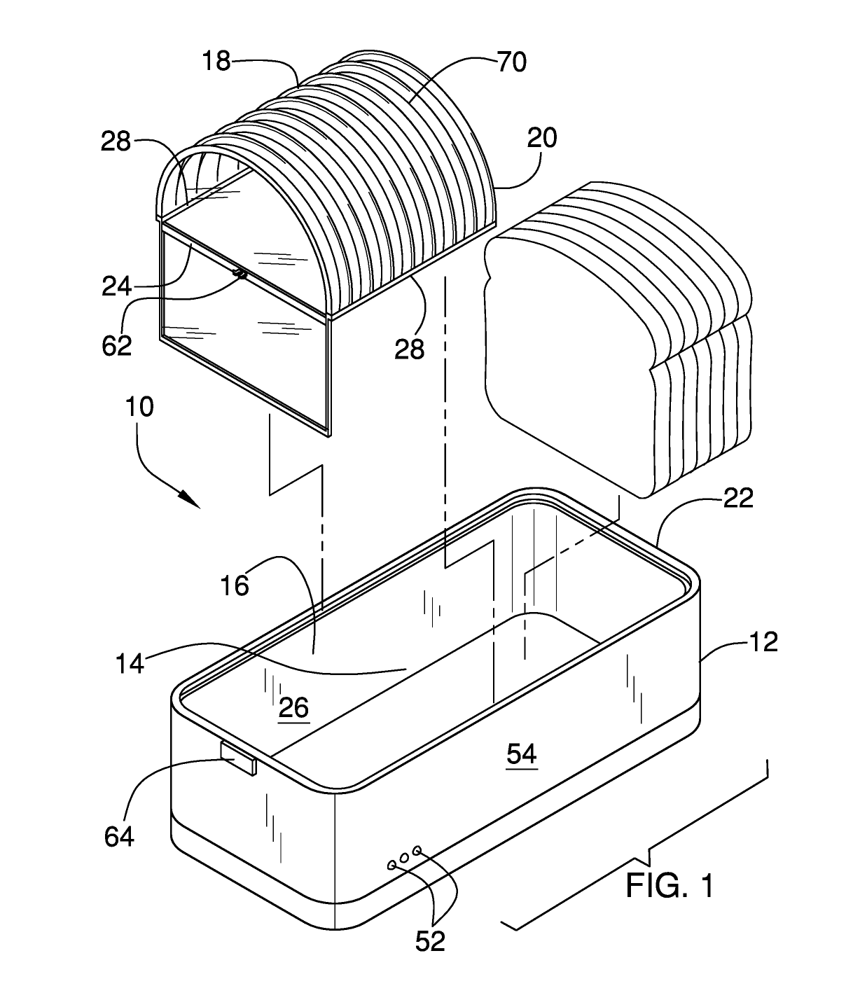

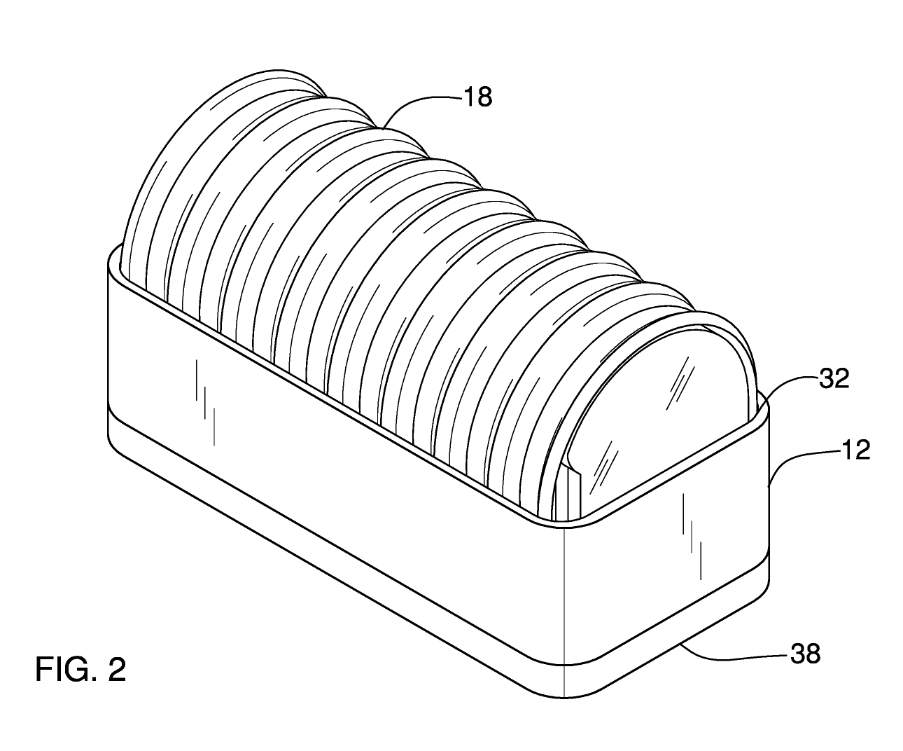

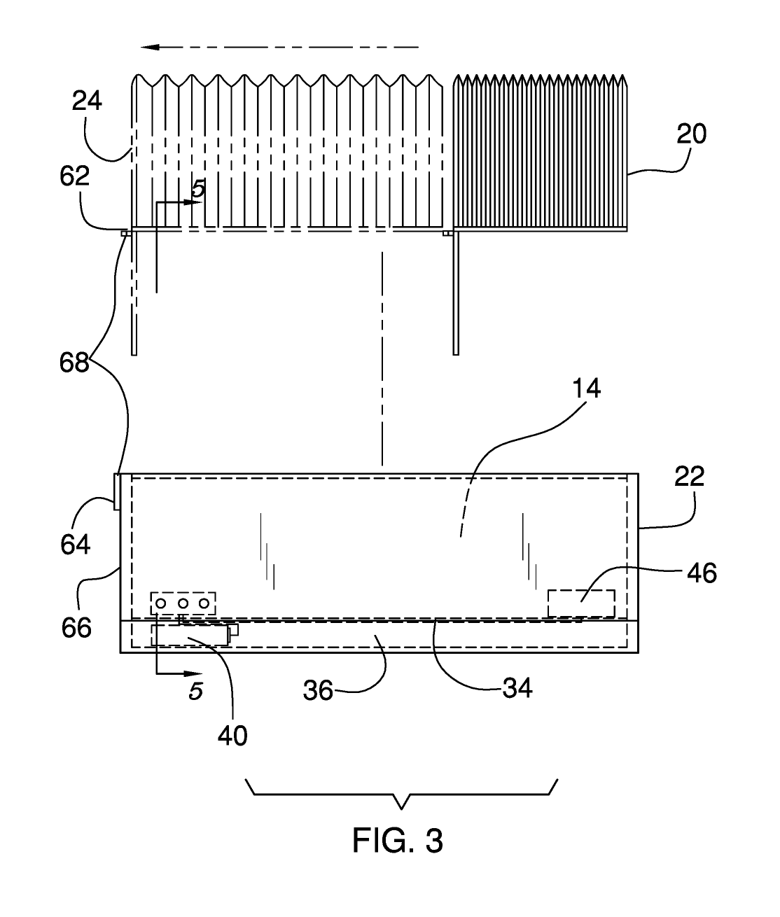

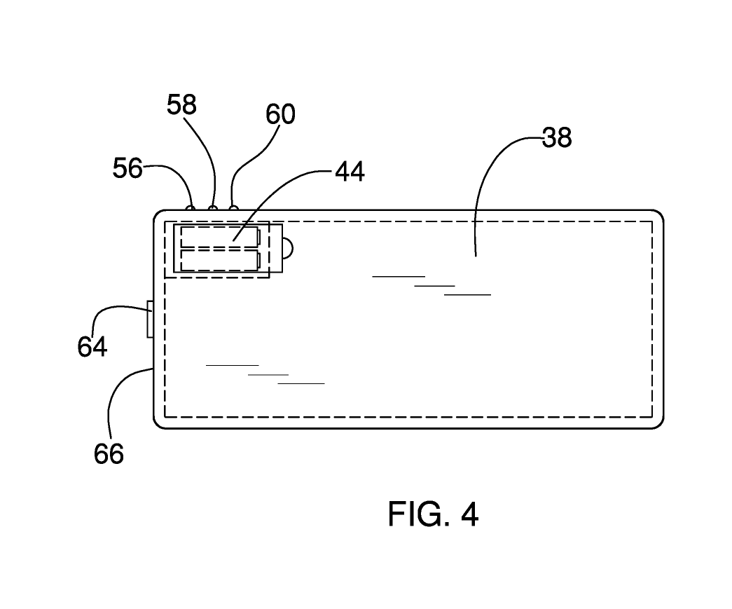

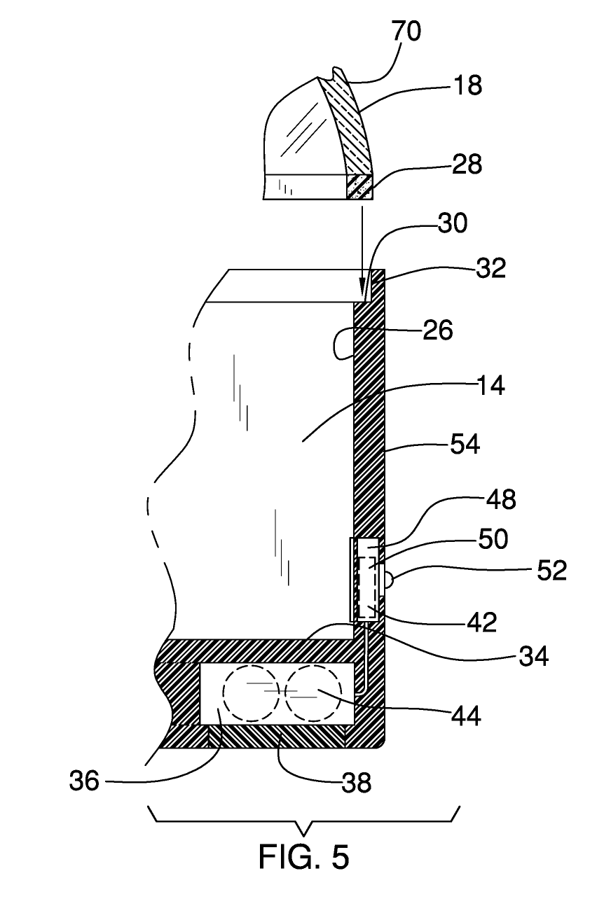

With reference now to the drawings, and in particular to FIGS. 1 through 5 thereof, a new storage container embodying the principles and concepts of an embodiment of the disclosure and generally designated by the reference numeral 10 will be described.

As best illustrated in FIGS. 1 through 5, the bread storage container 10 generally comprises a housing 12 that defines an internal space 14. The housing 12 has a top 16 that is open. The top 16 is positioned in the housing 12 such that the housing 12 is configured to insert a loaf of bread through the top 16 into the internal space 14. In one embodiment, the housing 12 is substantially rectangularly box shaped.

The container 10 comprises a lid 18 that is extendible. The lid 18 is substantially complementary to the top 16 when the lid 18 is in a fully extended configuration. The lid 18 is biased to a contracted configuration such that the lid 18 selectively conforms to a partial loaf of bread. The lid 18 is sealably and slidably couplable to the housing 12 to close the top 16 and seal the internal space 14. The lid 18 has a first end 20 that is sealably couplable to a first endpoint 22 of the housing 12. The lid 18 has a second end 24 that extends into the internal space 14. The second end 24 is sealably and slidably couplable to an interior surface 26 of the housing 12. The lid 18 has an upper surface 70 that extends between opposing sides 28. In one embodiment, the upper surface 70 is arcuate such that the loaf of bread can protrude through the top 16.

A ridge 30 is positioned in the housing 12 around a perimeter 32 of the top 16. The ridge 30 is positioned in the housing 12 such that the ridge 30 is positioned to sealably and slidably couple to the lid 18 to couple the lid 18 to the housing 12.

A panel 34 is coupled to the housing 12 and is positioned in the internal space 14. The panel 34 defines a chamber 36 that is positioned proximate to a bottom 38 of the housing 12.

A power module 40 and a microprocessor 42 are coupled to the housing 12 and are positioned in the chamber 36. The microprocessor 42 is operationally coupled to the power module 40. In one embodiment, the power module 40 comprises at least one battery 44.

A detector 46 is coupled to the housing 12. The detector 46 is configured to measure and indicate a pressure differential between the internal space 14 and an atmospheric pressure. In one embodiment, the detector 46 comprises a first sensor 48 and a second sensor 50. The first sensor 48 and the second sensor 50 are operationally coupled to the power module 40 and the microprocessor 42. The first sensor 48 is configured to measure a pressure within the internal space 14. The second sensor 50 is configured to measure the atmospheric pressure. The first sensor 48 and the second sensor 50 are positioned on the housing 12 such that the first sensor 48 and the second sensor 50 are configured to obtain pressure readings and relay the pressure readings to the microprocessor 42.

A display 52 is coupled to an exterior surface 54 of the housing 12. The display 52 is operationally coupled to the microprocessor 42. The display 52 is positioned on the housing 12 such that the display 52 is positioned to receive pressure differentials from the microprocessor 42. The display 52 is configured to notify a user of the pressure differentials. In one embodiment, the display 52 comprises a first light 56, a second light 58 and a third light 60. The first light 56 is configured to illuminate to notify the user when the pressure in the internal space 14 is lower than the atmospheric pressure. The second light 58 is configured to illuminate to notify the user when the pressure in the internal space 14 is higher than the atmospheric pressure. The third light 60 is configured to illuminate to notify the user when the pressure in the internal space 14 is substantially equivalent to the atmospheric pressure. In one embodiment, the first light 56 is green, the second light 58 is red, and the third light 60 is yellow.

A first fastener 62 is coupled to the second end 24 of the lid 18. A second fastener 64 is coupled to a second endpoint 66 of the housing 12 proximate to the top 16. The second fastener 64 is complementary to the first fastener 62. The second fastener 64 is positioned on the housing 12 such that the second fastener 64 is positioned to reversibly couple to the first fastener 62 to retain the lid 18 in the fully extended configuration. A full loaf of bread that is positioned in the internal space 14 is not subjected to a compressive force. In one embodiment, the first fastener 62 and the second fastener 64 comprises a snap lock 68.

In use, the top 16 is positioned in the housing 12 such that the housing 12 is configured to insert the loaf of bread through the top 16 into the internal space 14. The ridge 30 is positioned in the housing 12 such that the ridge 30 is positioned to sealably and slidably couple to the lid 18 to couple the lid 18 to the housing 12 to close the top 16 and seal the internal space 14. The first sensor 48 and the second sensor 50 are positioned on the housing 12 such that the first sensor 48 and the second sensor 50 are configured to obtain pressure readings and to relay the pressure readings to the microprocessor 42. The first light 56 is configured to illuminate to notify the user when the pressure in the internal space 14 is lower than the atmospheric pressure. The second light 58 is configured to illuminate to notify the user when the pressure in the internal space 14 is higher than the atmospheric pressure. The third light 60 is configured to illuminate to notify the user when the pressure in the internal space 14 is substantially equivalent to the atmospheric pressure.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bread storage container comprising:
a housing defining an internal space, said housing having a top, said top being open;
a lid, said lid being extendible such that said lid is substantially complementary to said top when said lid is in a fully extended configuration, said lid being biased to a contracted configuration such that said lid selectively conforms to a partial loaf of bread, said lid being sealably and slidably couplable to said housing to close said top and seal said internal space;
a detector coupled to said housing, said detector being configured for measuring and indicating a pressure differential between said internal space and an atmospheric pressure; and
wherein said top is positioned in said housing such that said housing is configured for insertion of the loaf of bread through said top into said internal space, such that said lid is sealably and slidably couplable to said housing to close said top and seal said internal space, wherein said detector is configured for measuring and indicating the pressure differential between said internal space and the atmospheric pressure.

2. The container of claim 1, further including said housing be substantially rectangularly box shaped.

3. The container of claim 1, further including said lid having a first end sealably couplable to a first endpoint of said housing, said lid having a second end extending into said internal space such that said second end is sealably and slidably couplable to an interior surface of said housing.

4. The container of claim 1, further including said lid having an upper surface extending between opposing sides, said upper surface being arcuate such that the loaf of bread can protrude through said top.

5. The container of claim 1, further including a ridge positioned in said housing around a perimeter of said top, wherein said ridge is positioned in said housing such that said ridge is positioned to sealably and slidably couple to said lid to couple said lid to said housing.

6. The container of claim 1, further comprising:
a panel coupled to said housing and positioned in said internal space defining a chamber proximate to a bottom of said housing;
a power module coupled to said housing and positioned in said chamber;
a microprocessor coupled to said housing and positioned in said chamber, said microprocessor being operationally coupled to said power module;
said detector comprising a first sensor and a second sensor, said first sensor and said second sensor being operationally coupled to said power module and said microprocessor, said first sensor being configured for measuring a pressure within said internal space, said second sensor being configured for measuring the atmospheric pressure;
a display coupled to an exterior surface of said housing, said display being operationally coupled to said microprocessor; and
wherein said first sensor and said second sensor are positioned on said housing such that said first sensor and said second sensor are configured for obtaining pressure readings and relaying the pressure readings to said microprocessor, wherein said display is positioned on said housing such that said display is positioned to receive pressure differentials from said microprocessor, such that said display is configured to notify a user of the pressure differentials.

7. The container of claim 6, further including said power module comprising at least one battery.

8. The container of claim 6, further including said display comprising a first light, a second light and a third light, wherein said first light is configured to illuminate to notify the user when the pressure in said internal space is lower than the atmospheric pressure, wherein said second light is configured to illuminate to notify the user when the pressure in said internal space is higher than the atmospheric pressure, and wherein said third light is configured to illuminate to notify the user when the pressure in said internal space is substantially equivalent to the atmospheric pressure.

9. The container of claim 8, further including said first light being green, said second light being red, said third light being yellow.

10. The container of claim 1, further comprising:
a first fastener coupled to said second end of said lid;
a second fastener coupled to a second endpoint of said housing proximate to said top, said second fastener being complementary to said first fastener; and
wherein said second fastener is positioned on said housing such that said second fastener is positioned to reversibly couple to said first fastener to retain said lid in the fully extended configuration, such that a full loaf of bread positioned in said internal space is not subjected to a compressive force.

11. The container of claim 10, further including said first fastener and said second fastener comprising a snap lock.

12. A bread storage container comprising:
a housing defining an internal space, said housing having a top, said top being open, wherein said top is positioned in said housing such that said housing is configured for insertion of a loaf of bread through said top into said internal space, said housing be substantially rectangularly box shaped;
a lid, said lid being extendible such that said lid is substantially complementary to said top when said lid is in a fully extended configuration, said lid being biased to a contracted configuration such that said lid selectively conforms to a partial loaf of bread, said lid being sealably and slidably couplable to said housing to close said top and seal said internal space, said lid having a first end sealably couplable to a first endpoint of said housing, said lid having a second end extending into said internal space such that said second end is sealably and slidably couplable to an interior surface of said housing, said lid having an upper surface extending between opposing sides, said upper surface being arcuate such that the loaf of bread can protrude through said top;
a ridge positioned in said housing around a perimeter of said top, wherein said ridge is positioned in said housing such that said ridge is positioned to sealably and slidably couple to said lid to couple said lid to said housing;
a panel coupled to said housing and positioned in said internal space defining a chamber proximate to a bottom of said housing;
a power module coupled to said housing and positioned in said chamber, said power module comprising at least one battery;
a microprocessor coupled to said housing and positioned in said chamber, said microprocessor being operationally coupled to said power module;
a detector coupled to said housing, said detector being configured for measuring and indicating a pressure differential between said internal space and an atmospheric pressure, said detector comprising a first sensor and a second sensor, said first sensor and said second sensor being operationally coupled to said power module and said microprocessor, said first sensor being configured for measuring a pressure within said internal space, said second sensor being configured for measuring the atmospheric pressure, wherein said first sensor and said second sensor are positioned on said housing such that said first sensor and said second sensor are configured for obtaining pressure readings and relaying the pressure readings to said microprocessor;
a display coupled to an exterior surface of said housing, said display being operationally coupled to said microprocessor, wherein said display is positioned on said housing such that said display is positioned to receive pressure differentials from said microprocessor, such that said display is configured to notify a user of the pressure differentials, said display comprising a first light, a second light and a third light, wherein said first light is configured to illuminate to notify the user when the pressure in said internal space is lower than the atmospheric pressure, wherein said second light is configured to illuminate to notify the user when the pressure in said internal space is higher than the atmospheric pressure, and wherein said third light is configured to illuminate to notify the user when the pressure in said internal space is substantially equivalent to the atmospheric pressure, said first light being green, said second light being red, said third light being yellow;
a first fastener coupled to said second end of said lid;
a second fastener coupled to a second endpoint of said housing proximate to said top, said second fastener being complementary to said first fastener, wherein said second fastener is positioned on said housing such that said second fastener is positioned to reversibly couple to said first fastener to retain said lid in the fully extended configuration, such that a full loaf of bread positioned in said internal space is not subjected to a compressive force, said first fastener and said second fastener comprising a snap lock; and
wherein said top is positioned in said housing such that said housing is configured for insertion of the loaf of bread through said top into said internal space, wherein said ridge is positioned in said housing such that said ridge is positioned to sealably and slidably couple to said lid to couple said lid to said housing to close said top and seal said internal space, wherein said first sensor and said second sensor are positioned on said housing such that said first sensor and said second sensor are configured for obtaining pressure readings and relaying the pressure readings to said microprocessor, wherein said first light is configured to illuminate to notify the user when the pressure in said internal space is lower than the atmospheric pressure, wherein said second light is configured to illuminate to notify the user when the pressure in said internal space is higher than the atmospheric pressure, and wherein said third light is configured to illuminate to notify the user when the pressure in said internal space is substantially equivalent to the atmospheric pressure.
